(19) United States
(12) Patent Application Publication
(10) Pub. No.: US 2026/0238986 A1
(43) Pub. Date: Aug. 13, 2026

(54) METHOD AND APPARATUS FOR APPLICATION SPECIFIC DATA STORAGE

(71) Applicant: Telefonaktiebolaget LM Ericsson (publ), Stockholm (SE)

(72) Inventors: Ping CHEN, Shanghai (CN); Emiliano MERINO VAZQUEZ, Madrid (ES); Qiang LIU, Shanghai (CN); Haiming CHENG, Shanghai (CN); Jingrui TAO, Guangzhou (CN)

(21) Appl. No.: 19/155,477

(22) PCT Filed: Feb. 5, 2024
(86) PCT No.: PCT/CN2024/075984

§ 371 Date: Aug. 11, 2025

(30) Foreign Application Priority Data
Feb. 15, 2023 (WO) PCT/CN2023/076200

(51) Int. Cl. H04W 8/20; H04W 4/50; H04W 12/72

(52) U.S. Cl. CPC H04W 8/20; H04W 4/50; H04W 12/72

(57) ABSTRACT

Embodiments of the present disclosure provide method and apparatus for application specific data storage. A method performed by an exposure function node includes receiving a first request comprising application specific data, an application identifier, a first subscriber identifier from an application node. The method further includes sending a second request comprising the application specific data, the application identifier, the first subscriber identifier or a second identifier associated to the first subscriber identifier to a data repository node.

### PRIORITY CLAIM

This application claims the priority of a PCT application with International Application No. PCT/CN2023/076200 and International Filing Date Feb. 15, 2023.

### TECHNICAL FIELD

The non-limiting and exemplary embodiments of the present disclosure generally relate to the technical field of communications, and specifically to methods and apparatuses for application specific data (ASD) storage.

### BACKGROUND

This section introduces aspects that may facilitate a better understanding of the disclosure. Accordingly, the statements of this section are to be read in this light and are not to be understood as admissions about what is in the prior art or what is not in the prior art.

An application may require a user (or subscriber) to have a subscription/entitlement. If the subscriber has also a MNO (Mobile Network Operator) subscription (e.g. the subscriber has a mobile subscriber integrated services digital network number (MSISDN) associated to the MNO subscription), it may need to be known by the application. So the linkage of the application entitlement/subscription (e.g. application account) and the MNO subscription needs to be kept in a storage of the application. That is, all application-specific data related to the MNO subscription such as mobile subscriber/MSISDN, if required, needs to be stored in the storage of the application.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Given the nature of the applications' entitlement and the requirements when it comes to application storage (that is, persistency), it requires the application to mount a reliable storage, which contains the MSISDN of the user in many cases (e.g. to be able to confirm access to the application via Short Message Service (SMS)). In addition to this need, both data can be inconsistent, meaning that if the user changes his MNO subscription, or the MNO subscription is removed, there is no easy way for the applications to be aware of this, or even to check whether the MNO subscription associated to the user's entitlement (e.g. application account) is still valid. In short: the MNO does not provide any mechanism for the applications to store/retrieve application specific data (only of interest to the application, that is, not used by the MNO), once the MNO subscription is known (i.e. once the MSISDN is known at user's account creation).

To overcome or mitigate at least one of above mentioned problems or other problems, the embodiments of the present disclosure propose an improved solution for application specific data storage.

In a first aspect of the disclosure, there is provided a method performed by an exposure function node. The method comprises receiving a first request comprising application specific data, an application identifier, a first subscriber identifier from an application node. The method further comprises sending a second request comprising the application specific data, the application identifier, the first subscriber identifier or a second identifier associated to the first subscriber identifier to a data repository node.

In an embodiment, the first request comprises at least one of a service parameter create request, or an application specific data storage create request.

In an embodiment, the second request comprises a data management create request.

In an embodiment, an access to the application specific data is only offered to an application managing the application specific data.

In an embodiment, the application specific data comprises information in a form of attribute and value pairs.

In an embodiment, the first subscriber identifier comprises at least one of a mobile subscriber integrated services digital network number (MSISDN) or an external identifier.

In an embodiment, the second identifier comprises a user equipment identifier.

In an embodiment, the user equipment identifier comprises at least one of an international mobile subscription identity (IMSI) or a subscription permanent identifier (SUPI).

In an embodiment, the method further comprises authorizing the first request for the application node, when an authorization of the first request for the application node is not granted, sending to the application node a first response comprising information indicating the authorization of the first request for the application node is not granted and/or skipping sending the second request to the data repository node.

In an embodiment, the method further comprises sending a first service specific authorization create request comprising the first subscriber identifier, a service type corresponding to the application specific data, and the application identifier to a data management node. The method further comprises receiving a first service specific authorization create response comprising an authorization result from the data management node. The method further comprises, when the authorization result indicates that a service specific authorization is not granted, sending to the application node a first response comprising information indicating the service specific authorization is not granted and/or skipping sending the second request to the data repository node.

In an embodiment, the method further comprises receiving a second response comprising information indicating the application specific data has been stored in the data repository node from the data repository node. The method further comprises sending a first response comprising information indicating the application specific data has been stored in the data repository node to the application node.

In an embodiment, the method further comprises receiving a third request for retrieving or updating or modifying or deleting the application specific data for the first subscriber identifier and the application identifier or for the application identifier from the application node. The method further comprises sending a fourth request for retrieving or updating or modifying or deleting the application specific data for the first subscriber identifier and the application identifier or for the application identifier to the data repository node. The method further comprises receiving a fourth response comprising a retrieving result or an updating result or a modifying result or a deleting result from the data repository node. The method further comprises sending a third response comprising the retrieving result or the updating result or the modifying result or the deleting result to the application node.

In an embodiment, the third request comprises at least one of a service parameter get request, an application specific data get request, a service parameter update request, an application specific data storage update request, a service parameter modification request, an application specific data storage modification request, a service parameter delete request, or an application specific data delete request.

In an embodiment, the fourth request comprises at least one of a data management query request, a data management update request, or a data management delete request.

In an embodiment, the method further comprises authorizing the third request for the application node. The method further comprises, when an authorization of the third request for the application node is not granted, sending to the application node a third response comprising information indicating that the authorization of the third request for the application node is not granted and/or skipping sending the fourth request to the data repository node.

In an embodiment, the method further comprises sending a second service specific authorization create request comprising the first subscriber identifier, a service type corresponding to the application specific data, and the application identifier to a data management node. The method further comprises receiving a second service specific authorization create response comprising an authorization result from the data management node. The method further comprises when the authorization result indicates that a service specific authorization is not granted, sending to the application node a third response comprising information indicating the service specific authorization is not granted and/or skipping sending the fourth request to the data repository node.

In an embodiment, the exposure function node comprises a network exposure function (NEF).

In an embodiment, the application node comprises at least one of an application servers (AS), a services capability server (SCS), or an application function (AF).

In an embodiment, the data repository node comprises a unified data repository (UDR).

In a second aspect of the disclosure, there is provided a method performed by a data repository node. The method comprises receiving a second request comprising application specific data, an application identifier, a first subscriber identifier or a second identifier associated to the first subscriber identifier from an exposure function node. The method further comprises storing the application specific data for the application identifier and the first subscriber identifier or the second identifier associated to the first subscriber identifier. The method further comprises sending a second response comprising information indicating the application specific data has been stored in the data repository node to the exposure function node.

In an embodiment, the second request comprises a data management create request.

In an embodiment, an access to the application specific data is only offered to an application managing the application specific data.

In an embodiment, the application specific data comprises information in a form of attribute and value pairs.

In an embodiment, the first subscriber identifier comprises at least one of a mobile subscriber integrated services digital network number (MSISDN), or an external identifier.

In an embodiment, the second identifier comprises a user equipment identifier.

In an embodiment, the user equipment identifier comprises at least one of an international mobile subscription identity (IMSI), or a subscription permanent identifier (SUPI).

In an embodiment, the method further comprises receiving a fourth request for retrieving or updating or modifying or deleting the application specific data for the first subscriber identifier and the application identifier or for the application identifier from the exposure function node. The method further comprises sending a fourth response comprising a retrieving result or an updating result or a modifying result or a deleting result to the exposure function node.

In an embodiment, the fourth request comprises at least one of a data management query request, a data management update request, or a data management delete request.

In an embodiment, the exposure function node comprises a network exposure function (NEF).

In an embodiment, the data repository node comprises a unified data repository (UDR).

In a third aspect of the disclosure, there is provided a method performed by a data management node. The method comprises receiving a service specific authorization create request comprising a first subscriber identifier, a service type corresponding to application specific data, and an application identifier from an exposure function node. The method further comprises sending a service specific authorization create response comprising an authorization result to the exposure function node.

In an embodiment, an access to the application specific data is only offered to an application managing the application specific data.

In an embodiment, the application specific data comprises information in a form of attribute and value pairs.

In an embodiment, the first subscriber identifier comprises at least one of a mobile subscriber integrated services digital network number (MSISDN), or an external identifier.

In an embodiment, the exposure function node comprises a network exposure function (NEF).

In an embodiment, the data management node comprises a Unified Data Management (UDM).

In a fourth aspect of the disclosure, there is provided a method performed by an application node. The method comprises sending a first request comprising application specific data, an application identifier, a first subscriber identifier to an exposure function node. The method further comprises receiving a first response from the exposure function node.

In an embodiment, the first request comprises at least one of a service parameter create request, or an application specific data storage create request.

In an embodiment, an access to the application specific data is only offered to an application managing the application specific data.

In an embodiment, the application specific data comprises information in a form of attribute and value pairs.

In an embodiment, the first subscriber identifier comprises at least one of a mobile subscriber integrated services digital network number (MSISDN), or an external identifier.

In an embodiment, the first response comprises at least one of information indicating an authorization of the first request for the application node is not granted, information indicating a service specific authorization is not granted, or information indicating the application specific data has been stored in a data repository node.

In an embodiment, when the first response comprises the information indicating the service specific authorization is not granted, it indicates that an association of a network operator subscription of a user and an application subscription of the user is not valid.

In an embodiment, when the first response comprises the information indicating the application specific data has been stored in a data repository node, it indicates that an association of a network operator subscription of a user and an application subscription of the user is valid.

In an embodiment, the method further comprises sending a third request for retrieving or updating or modifying or deleting the application specific data for the first subscriber identifier and the application identifier or for the application identifier to the exposure function node. The method further comprises receiving a third response from the exposure function node.

In an embodiment, the third request comprises at least one of a service parameter get request, an application specific data get request, a service parameter update request, an application specific data storage update request, a service parameter modification request, an application specific data storage modification request, a service parameter delete request, or an application specific data delete request.

In an embodiment, the third response comprises at least one of a retrieving result, an updating result, a modifying result, a deleting result, information indicating an authorization of the third request for the application node is not granted, or information indicating a service specific authorization is not granted.

In an embodiment, when the third response comprises the information indicating the service specific authorization is not granted, it indicates that an association of a network operator subscription of a user and an application subscription of the user is not valid.

In an embodiment, when the third response comprises the application specific data for the first subscriber identifier and the application identifier, it indicates that an association of a network operator subscription of a user and an application subscription of the user is valid.

In an embodiment, the exposure function node comprises a network exposure function (NEF).

In an embodiment, the application node comprises at least one of an application servers (AS), a services capability server (SCS), or an application function (AF).

In a fifth aspect of the disclosure, there is provided an exposure function node. The exposure function node comprises a processor and a memory coupled to the processor. Said memory contains instructions executable by said processor. Said exposure function node is operative to receive a first request comprising application specific data, an application identifier, a first subscriber identifier from an application node. Said exposure function node is further operative to send a second request comprising the application specific data, the application identifier, the first subscriber identifier or a second identifier associated to the first subscriber identifier to a data repository node.

In a sixth aspect of the disclosure, there is provided a data repository node. The data repository node comprises a processor and a memory coupled to the processor. Said memory contains instructions executable by said processor. Said data repository node is operative to receive a second request comprising application specific data, an application identifier, a first subscriber identifier or a second identifier associated to the first subscriber identifier from an exposure function node. Said data repository node is further operative to store the application specific data for the application identifier and the first subscriber identifier or the second identifier associated to the first subscriber identifier. Said data repository node is further operative to send a second response comprising information indicating the application specific data has been stored in the data repository node to the exposure function node.

In a seventh aspect of the disclosure, there is provided a data management node. The data management node comprises a processor and a memory coupled to the processor. Said memory contains instructions executable by said processor. Said data management node is operative to receive a service specific authorization create request comprising a first subscriber identifier, a service type corresponding to application specific data, and an application identifier from an exposure function node. Said data management node is further operative to send a service specific authorization create response comprising an authorization result to the exposure function node.

In an eighth aspect of the disclosure, there is provided an application node. The application node comprises a processor and a memory coupled to the processor. Said memory contains instructions executable by said processor. Said application node is operative to send a first request comprising application specific data, an application identifier, a first subscriber identifier to an exposure function node. Said application node is further operative to receive a first response from the exposure function node.

In another aspect of the disclosure, there is provided an exposure function node. The exposure function node comprises a first receiving module configured to receive a first request comprising application specific data, an application identifier, a first subscriber identifier from an application node. The exposure function node further comprises a first sending module configured to send a second request comprising the application specific data, the application identifier, the first subscriber identifier or a second identifier associated to the first subscriber identifier to a data repository node.

In an embodiment, the exposure function node further comprises a first authorizing module configured to authorize the first request for the application node.

In an embodiment, the exposure function node further comprises a second sending module configured to, when an authorization of the first request for the application node is not granted, send to the application node a first response comprising information indicating the authorization of the first request for the application node is not granted.

In an embodiment, the exposure function node further comprises a first skipping module configured to, when an authorization of the first request for the application node is not granted, skip sending the second request to the data repository node.

In an embodiment, the exposure function node further comprises a third sending module configured to send a first service specific authorization create request comprising the first subscriber identifier, a service type corresponding to the application specific data, and the application identifier to a data management node.

In an embodiment, the exposure function node further comprises a second receiving module configured to receive a first service specific authorization create response comprising an authorization result from the data management node.

In an embodiment, the exposure function node further comprises a fourth sending module configured to, when the authorization result indicates that a service specific authorization is not granted, send to the application node a first response comprising information indicating the service specific authorization is not granted.

In an embodiment, the exposure function node further comprises a second skipping module configured to, when the authorization result indicates that a service specific authorization is not granted, skip sending the second request to the data repository node.

In an embodiment, the exposure function node further comprises a third receiving module configured to receive a second response comprising information indicating the application specific data has been stored in the data repository node from the data repository node.

In an embodiment, the exposure function node further comprises a fifth sending module configured to send a first response comprising information indicating the application specific data has been stored in the data repository node to the application node.

In an embodiment, the exposure function node further comprises a fourth receiving module configured to receive a third request for retrieving or updating or modifying or deleting the application specific data for the first subscriber identifier and the application identifier or for the application identifier from the application node.

In an embodiment, the exposure function node further comprises a sixth sending module configured to send a fourth request for retrieving or updating or modifying or deleting the application specific data for the first subscriber identifier and the application identifier or for the application identifier to the data repository node.

In an embodiment, the exposure function node further comprises a fifth receiving module configured to receive a fourth response comprising a retrieving result or an updating result or a modifying result or a deleting result from the data repository node.

In an embodiment, the exposure function node further comprises a seventh sending module configured to send a third response comprising the retrieving result or the updating result or the modifying result or the deleting result to the application node.

In an embodiment, the exposure function node further comprises a second authorizing module configured to authorize the third request for the application node.

In an embodiment, the exposure function node further comprises an eighth sending module configured to, when an authorization of the third request for the application node is not granted, send to the application node a third response comprising information indicating that the authorization of the third request for the application node is not granted.

In an embodiment, the exposure function node further comprises a third skipping module configured to, when an authorization of the third request for the application node is not granted, skip sending the fourth request to the data repository node.

In an embodiment, the exposure function node further comprises a ninth sending module configured to send a second service specific authorization create request comprising the first subscriber identifier, a service type corresponding to the application specific data, and the application identifier to a data management node.

In an embodiment, the exposure function node further comprises a sixth receiving module configured to receive a second service specific authorization create response comprising an authorization result from the data management node.

In an embodiment, the exposure function node further comprises a tenth sending module configured to, when the authorization result indicates that a service specific authorization is not granted, send to the application node a third response comprising information indicating the service specific authorization is not granted.

In an embodiment, the exposure function node further comprises a fourth skipping module configured to, when the authorization result indicates that a service specific authorization is not granted, skip sending the fourth request to the data repository node.

In another aspect of the disclosure, there is provided a data repository node. The data repository node comprises a first receiving module configured to receive a second request comprising application specific data, an application identifier, a first subscriber identifier or a second identifier associated to the first subscriber identifier from an exposure function node. The data repository node further comprises a storing module configured to store the application specific data for the application identifier and the first subscriber identifier or the second identifier associated to the first subscriber identifier. The data repository node further comprises a first sending module configured to send a second response comprising information indicating the application specific data has been stored in the data repository node to the exposure function node.

In an embodiment, the data repository node further comprises a second receiving module configured to receive a fourth request for retrieving or updating or modifying or deleting the application specific data for the first subscriber identifier and the application identifier or for the application identifier from the exposure function node.

In an embodiment, the data repository node further comprises a second sending module configured to send a fourth response comprising a retrieving result or an updating result or a modifying result or a deleting result to the exposure function node.

In another aspect of the disclosure, there is provided a data management node. The data management node comprises a receiving module configured to receive a service specific authorization create request comprising a first subscriber identifier, a service type corresponding to application specific data, and an application identifier from an exposure function node. The data management node further comprises a sending module configured to send a service specific authorization create response comprising an authorization result to the exposure function node.

In another aspect of the disclosure, there is provided an application node. The application node comprises a first sending module configured to send a first request comprising application specific data, an application identifier, a first subscriber identifier to an exposure function node. The application node further comprises a first receiving module configured to receive a first response from the exposure function node.

In an embodiment, the application node further comprises a second sending module configured to send a third request for retrieving or updating or modifying or deleting the application specific data for the first subscriber identifier and the application identifier or for the application identifier to the exposure function node.

In an embodiment, the application node further comprises a second receiving module configured to receive a third response from the exposure function node.

In another aspect of the disclosure, there is provided a computer-readable storage medium storing instructions which when executed by at least one processor, cause the at least one processor to perform the method according to any one of the first, second, third or fourth aspects.

In another aspect of the disclosure, there is provided a computer program product comprising instructions which when executed by at least one processor, cause the at least one processor to perform the method according to any one of the first, second, third or fourth aspects.

Embodiments herein may provide many advantages, of which a non-exhaustive list of examples follows. In some embodiments herein, it may allow applications to use the MNO's network in a sort of Storage as a Service (Saas) by exposing (via API) the reliability and robustness of the network (e.g., 5GS) subscription data repository (e.g., UDR). In some embodiments herein, applications no longer require a local storage and a synchronization of the MNO subscription and the application's account, since the ASD is keyed/accessed by using directly the subscriber identifier such as MSISDN. In some embodiments herein, it may allow applications to store and query ASD in an open/flexible and extensible format in MNO's central repository (e.g., UDR) to offer the redundancy, persistency, high availability (e.g. via data replication and/or distributed database) of ASD data in MNO network. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a schematically shows system architecture in a 4G network according to an embodiment of the present disclosure;

FIG. 1b schematically shows a high level architecture in the fifth generation network according to an embodiment of the present disclosure;

FIG. 1c schematically shows a system architecture for service exposure for EPC-5GC interworking according to an embodiment of the present disclosure;

FIG. 1d schematically shows a data storage architecture according to an embodiment of the present disclosure;

FIG. 1e shows resource URI structure of the Nudr_DataRepository API for application data according to an embodiment of the present disclosure;

FIG. 2a shows a flowchart of a method according to an embodiment of the present disclosure;

FIG. 2b shows a new resource model for the ASD in UDR according to an embodiment of the present disclosure;

FIG. 2c shows a flowchart of a method according to another embodiment of the present disclosure;

FIG. 2d shows a flowchart of a method according to another embodiment of the present disclosure;

FIG. 2e shows a flowchart of a method according to another embodiment of the present disclosure;

FIG. 2f shows a flowchart of a method according to another embodiment of the present disclosure;

FIG. 2g shows a flowchart of a method according to another embodiment of the present disclosure;

FIG. 2h shows a flowchart of a method according to another embodiment of the present disclosure;

FIG. 3a shows a flowchart of a method according to another embodiment of the present disclosure;

FIG. 3b shows a flowchart of a method according to another embodiment of the present disclosure;

FIG. 4 shows a flowchart of a method according to another embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a method according to another embodiment of the present disclosure;

FIG. 8a is a block diagram showing an apparatus suitable for practicing some embodiments of the disclosure;

FIG. 8b is a block diagram showing an exposure function node according to an embodiment of the disclosure;

FIG. 8c is a block diagram showing a data repository node according to an embodiment of the disclosure;

FIG. 8d is a block diagram showing a data management node according to another embodiment of the disclosure;

FIG. 8e is a block diagram showing an application node according to another embodiment of the disclosure;

FIG. 9 shows an example of a communication system according to an embodiment of the disclosure;

FIG. 10 is a block diagram of a host according to an embodiment of the disclosure; and

FIG. 11 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

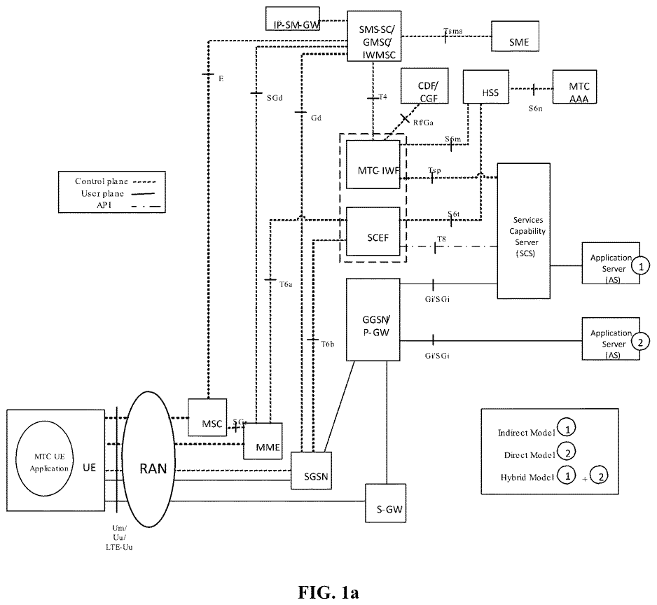

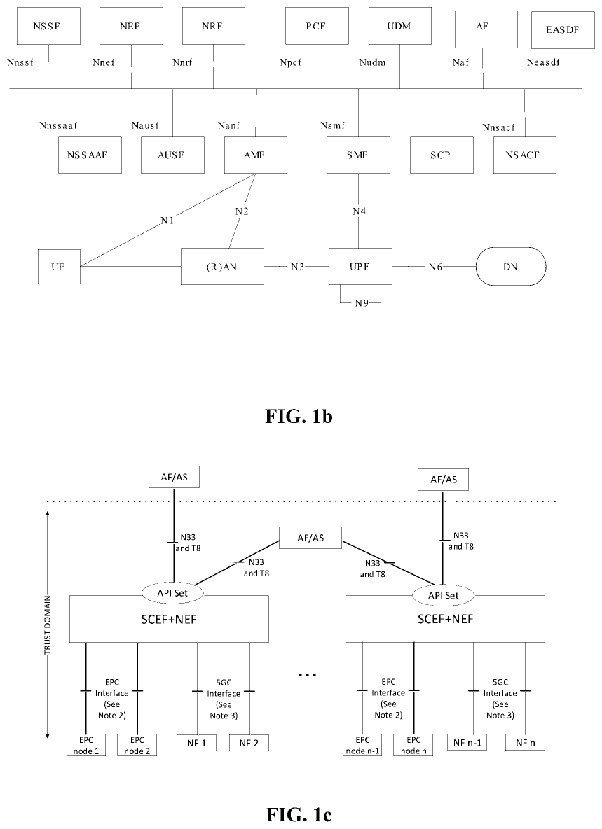

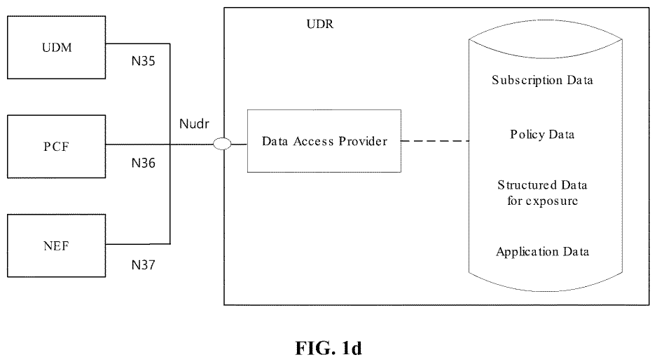

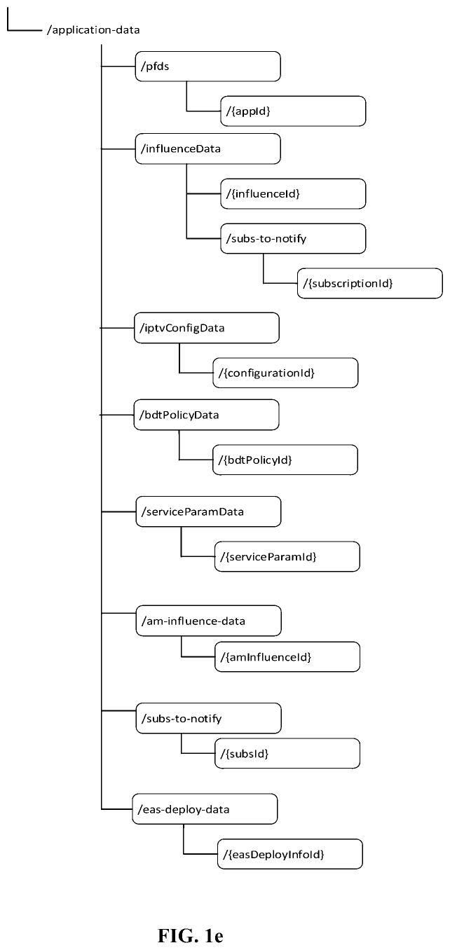

Although the subject matter described herein may be implemented in any appropriate type of system using any suitable components, the embodiments disclosed herein are described in relation to a communication system complied with the exemplary system architectures illustrated in FIG. 1a-1c. For simplicity, the system architectures of FIG. 1a-1c only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 1a schematically shows system architecture in a 4G network according to an embodiment of the present disclosure, which is the same as FIG. 4.2-1a of 3GPP TS 23.682 V17.3.0, the disclosure of which is incorporated by reference herein in its entirety. The system architecture of FIG. 1a may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 1a may be same as the corresponding network elements and interfaces as described in 3GPP TS 23.682 V17.3.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 1a, the exemplary system architecture also contains various reference points.
Tsms: Reference point used by an entity outside the 3GPP network to communicate with UEs used for MTC via SMS (Short Message Service).
Tsp: Reference point used by a SCS to communicate with the MTC-IWF related control plane signalling.
T4: Reference point used between MTC-IWF and the SMS-SC in the HPLMN.
T6a: Reference point used between SCEF and serving MME.
T6b: Reference point used between SCEF and serving SGSN.
T8: Reference point used between the SCEF and the SCS/AS.
S6m: Reference point used by MTC-IWF to interrogate HSS/HLR (Home Location Register).
S6n: Reference point used by MTC-AAA to interrogate HSS/HLR.
S6t: Reference point used between SCEF and HSS.
SGs: Reference point used between MSC and MME.
Gi/SGi: Reference point used between GGSN/P-GW and application server and between GGSN/P-GW and SCS.
Rf/Ga: Reference point used between MTC-IWF and CDF/CGF.
Gd: Reference point used between SMS-SC/GMSC/IWMSC and SGSN.
SGd: Reference point used between SMS-SC/GMSC/IWMSC and MME.
E: Reference point used between SMS-SC/GMSC/IWMSC and MSC.

The end-to-end communications, between the MTC Application in the UE and the MTC Application in the external network, uses services provided by the 3GPP system, and optionally services provided by a Services Capability Server (SCS).

The MTC Application in the external network is typically hosted by an Application Server (AS) and may make use of an SCS for additional value added services. The 3GPP system provides transport, subscriber management and other communication services including various architectural enhancements motivated by, but not restricted to, MTC (e.g. control plane device triggering).

Different models are foreseen for machine type of traffic in what relates to the communication between the AS and the 3GPP system and based on the provider of the SCS. The different architectural models that are supported by the Architectural Reference model include the Direct model, Indirect model and Hybrid model as described in 3GPP TS 23.682 V17.3.0.

FIG. 1b schematically shows a high level architecture in the fifth generation network according to an embodiment of the present disclosure. For example, the fifth generation network may be 5GS. The architecture of FIG. 1b is same as FIG. 4.2.3-1 of 3GPP TS 23.501 V18.0.0, the disclosure of which is incorporated by reference herein in its entirety. The system architecture of FIG. 1b may comprise some exemplary elements such as AUSF, AMF, DN (data network), NEF, NRF, NSSF, PCF, SMF, UDM, UPF, AF, UE, (R) AN, SCP (Service Communication Proxy), NSSAAF (Network Slice-Specific Authentication and Authorization Function), NSACF (Network Slice Admission Control Function), Edge Application Server Discovery Function (EASDF), etc.

In accordance with an exemplary embodiment, the UE can establish a signaling connection with the AMF over the reference point N1, as illustrated in FIG. 1b. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 1b, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1b also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

FIG. 1c schematically shows a system architecture for service exposure for EPC (evolved packet core)-5GC (5G core network) interworking according to an embodiment of the present disclosure, which is the same as FIG. 4.3.5.1-1 of 3GPP TS 23.501 V18.0.0. For example, if a UE is capable of mobility between EPS (evolved packet system) and 5GS (5G system), the network (such as EPC or 5GC) is expected to associate the UE with a combined SCEF and NEF (also called an SCEF+NEF node) for service capability exposure. The system architecture of FIG. 1c may comprise some exemplary elements such as AF/AS, SCEF+NEF, EPC node, NF, etc. The network elements and interfaces as shown in FIG. 1c may be same as the corresponding network elements and interfaces as described in 3GPP TS 23.501 V18.0.0 and 3GPP TS 23.682 V17.3.0.

FIG. 1d schematically shows a data storage architecture according to an embodiment of the present disclosure, which is the same as FIG. 4.2.5-2 of 3GPP TS 23.501 V18.0.0.

As depicted in FIG. 1d, the 5G System architecture allows the UDM, PCF and NEF to store data in the Unified Data Repository (UDR), including subscription data and policy data by UDM and PCF, structured data for exposure and application data (including Packet Flow Descriptions (PFDs) for application detection, AF request information for multiple UEs) by the NEF. UDR can be deployed in each PLMN and it can serve different functions as follows:
UDR accessed by the NEF belongs to the same PLMN where the NEF is located.
UDR accessed by the UDM belongs to the same PLMN where the UDM is located if UDM supports a split architecture.
UDR accessed by the PCF belongs to the same PLMN where the PCF is located.

There can be multiple UDRs deployed in the network, each of which can accommodate different data sets or subsets, (e.g. subscription data, subscription policy data, data for exposure, application data) and/or serve different sets of NFs. Deployments where a UDR serves a single NF and stores its data, and, thus, can be integrated with this NF, can be possible.

The internal structure of the UDR in FIG. 1d is shown for information only.

The Nudr interface is defined for the network functions (i.e. NF Service Consumers), such as NEF, to access a particular set of the data stored and to read, update (including add, modify), delete, and subscribe to notification of relevant data changes in the UDR.

Each NF Service Consumer accessing the UDR, via Nudr, shall be able to add, modify, update or delete only the data it is authorized to change. This authorization shall be performed by the UDR on a per data set and NF service consumer basis and potentially on a per UE, subscription granularity.

The following data in the UDR sets exposed via Nudr to the respective NF service consumer and stored may comprise:
Subscription Data,
Policy Data,
Structured Data for exposure,
Application data: e.g., application specific data that the application managing the application specific data is able to add, modify, update, delete or get.

FIG. 1e shows resource Uniform Resource Identifier (URI) structure of the Nudr_DataRepository Application Programming Interface (API) for application data according to an embodiment of the present disclosure, which is same as FIG. 6.2.2-1 of 3GPP TS 29.519 V17.8.0, the disclosure of which is incorporated by reference herein in its entirety.

Table 6.2.2-1 of 3GPP TS 29.519 V17.8.0 provides an overview of the resources and applicable HTTP methods.

TABLE 6-2.2-1
Resources and methods overview

| | | HTTP method or | |
|---|---|---|---|
| Resource name | Resource URI | custom operation | Description |
| PFD Data | /application-data/pfds | GET | Retrieve PFDs for application identifier(s) |
| | | | identified by query parameter(s). |
| | | | Retrieve PFDs for all application |
| | | | identifier(s) if no query parameter is |
| | | | included in the Request URI. |
| Individual PFD Data | /application-data/pfds/{appId} | GET | Retrieve the corresponding PFDs of the |
| | | | specified application identifier. |
| | | DELETE | Delete the corresponding PFDs of the |
| | | | specified application identifier. |
| | | PUT | Create or update the corresponding PFDs |
| | | | for the specified application identifier. |
| Influence Data | /application-data/influenceData | GET | Retrieve the Session Influence Data of |
| | (NOTE) | | given services, S-NSSAIs and DNNs or |
| | | | Internal Group Identifiers or SUPIs. |
| Individual Influence | /application-data/influenceData/ | PUT | Create an individual Influence Data |
| Data | {influenceId} | | resource identified by {influenceId}, or |
| | (NOTE) | | modify all of the properties of an |
| | | | individual Influence Data resource |
| | | | identified by {influenceId}. |
| | | PATCH | Modify part of the properties of an |
| | | | individual Influence Data resource |
| | | | identified by {influenceId}. |
| | | DELETE | Delete an individual Influence Data |
| | | | resource identified by {influenceId}. |
| Influence Data | /application-data/influenceData/ | POST | Create a new Individual Influence Data |
| Subscription | subs-to-notify | | Subscription resource. |
| | (NOTE) | GET | Read subscriptions for a given S-NSSAI |
| | | | and DNN or Internal Group Identifier or |
| | | | SUPI. |
| Individual Influence | /application-data/influenceData/ | GET | Get an existing individual Influence Data |
| Data Subscription | subs-to-notify/{subscriptionId} | | Subscription resource identified by |
| | (NOTE) | | {subscriptionId}. |
| | | PUT | Modify an existing individual Influence |
| | | | Data Subscription resource identified by |
| | | | {subscriptionId}. |
| | | DELETE | Delete an individual Influence Data |
| | | | Subscription resource identified by |
| | | | {subscriptionId}. |
| Applied BDT Policy | /application-data/bdtPolicyData | GET | Retrieve the applied BDT policy data. |
| Data | (NOTE) | | |
| Individual Applied | /application-data/bdtPolicyData/{bdt | PUT | Create an individual applied BDT Policy |
| BDT Policy Data | PolicyId} | | Data resource identified by {bdtPolicyId}. |
| | (NOTE) | PATCH | Modify BDT Reference Id of an individual |
| | | | applied BDT Policy Data resource |
| | | | identified by {bdtPolicyId}. |
| | | DELETE | Delete an individual applied BDT Policy |
| | | | Data resource identified by {bdtPolicyId}. |
| IPTV Configurations | /application-data/iptvConfigData | GET | Retrieve IPTV configurations for |
| | (NOTE) | | configuration identifier(s), given |
| | | | S-NSSAI(s) and DNN(s), or SUPIs or |
| | | | Internal Group Identifiers |
| Individual IPTV | /application-data/iptvConfigData/ | PUT | Create an Individual IPTV Configuration |
| Configuation | {configurationId} | | resource identified by {configurationId}, |
| | (NOTE) | | or modify all the properties of an |
| | | | Individual IPTV Configuration resource |
| | | | identified by {configurationId}. |
| | | PATCH | Modify some properties of an Individual |
| | | | IPTV Configuration resource identified by |
| | | | {configurationId}. |
| | | DELETE | Delete an Individual IPTV Configuration |
| | | | resource identified by {configurationId} |
| Service Parameter Data | /application-data/serviceParamData | GET | Retrieve the Service Parameter Data of |
| | (NOTE) | | given services, S-NSSAIs and DNNs or |
| | | | Internal Group Identifiers or SUPIs. |
| Individual Service | /application-data/serviceParamData/ | PUT | Create an individual Service Parameter |
| Parameter Data | {serviceParamId} | | Data resource identified by |
| | (NOTE) | | {serviceParamId}, or modify all of the |
| | | | properties of an individual Service |
| | | | Parameter Data resource identified by |
| | | | {serviceParamId}. |
| | | PATCH | Modify part of the properties of an |
| | | | individual Service Parameter Data |
| | | | resource identified by {serviceParamId}. |
| | | DELETE | Delete an individual Service Parameter |
| | | | Data resource identified by |
| | | | {serviceParamId}. |
| AM Influence Data | /application-data/am-influence-data | GET | Retrieve the AM Influence Data of given |
| | | | S-NSSAIs and DNNs and/or Internal |
| | | | Group Identifiers or SUPIs. |
| Individual AM | /application-data/am-influence-data/ | PUT | Create an individual AM Influence Data |
| Influence Data | {amInfluenceId} | | resource identified by {amInfluenceId}, or |
| | | | modify all of the properties of an |
| | | | individual AM Influence Data resource |
| | | | identified by {amInfluenceId}. |
| | | PATCH | Modify part of the properties of an |
| | | | individual AM Influence Data resource |
| | | | identified by {amInfluenceId}. |
| | | DELETE | Delete an individual AM Influence Data |
| | | | resource identified by {amInfluenceId}. |
| ApplicationDataSubscriptions | /application-data/subs-to-notify | POST | Create a subscription to receive |
| | | | notification of application data changes. |
| | | GET | Read all the subscriptions, or subscriptions |
| | | | for given S-NSSAI and DNN or Internal |
| | | | Group Identifier or SUPI. |
| IndividualApplicationDataSubscription | /application-data/subs-to-notify/ | PUT | Modify a subscription to receive |
| | {subsId} | | notification of application data changes |
| | | | identified by {subsId}. |
| | | DELETE | Delete a subscription identified by |
| | | | {subsId}. |
| | | GET | Read an existing individual Subscription |
| | | | resource identified by {subsId}. |
| EAS Deployment | /application-data/eas-deploy-data | GET | Retrieve the EAS Deployment Information |
| Information Data | | | Data, given DNN(s), S-NSSAI(s), |
| | | | Application ID or Internal Group |
| | | | Identifiers. |
| Individual EAS | /application-data/eas-deploy-data/{e | GET | Read an existing individual EAS |
| Deployment | as DeployInfoId} | | Deployment Data identified by |
| Information Data | | | {easDeployInfoId}. |
| | | PUT | Create an individual EAS deployment |
| | | | information Data resource identified by |
| | | | {easDeployInfoId} or Update an |
| | | | individual EAS Deployment Data resource |
| | | | identified by {eas DeployInfold}. |
| | | DELETE | Delete an individual EAS Deployment |
| | | | Data resource identified by |
| | | | {easDeployInfoId}. |

(NOTE):
The path segment does not follow the related naming convention defined in 3GPP TS 29.501 [5]. The path segment is kept though as defined in the current specification for backward compatibility considerations.

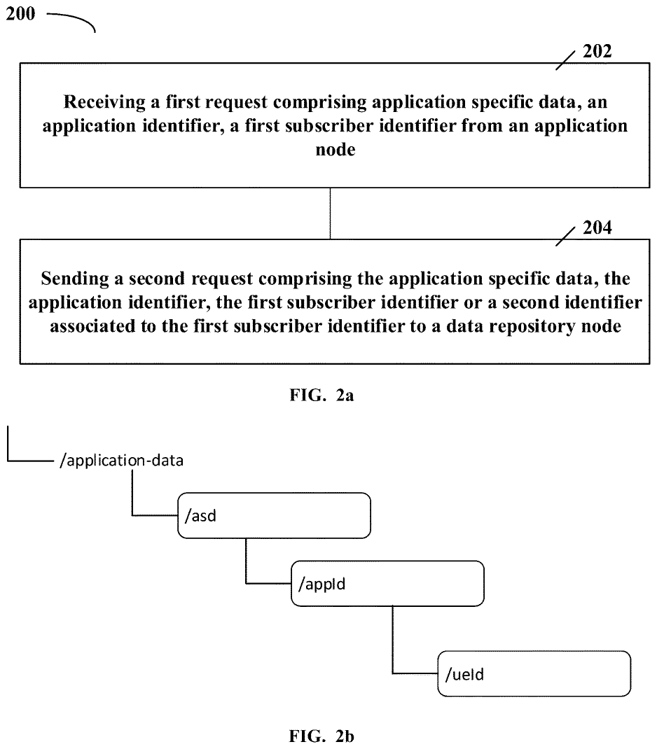

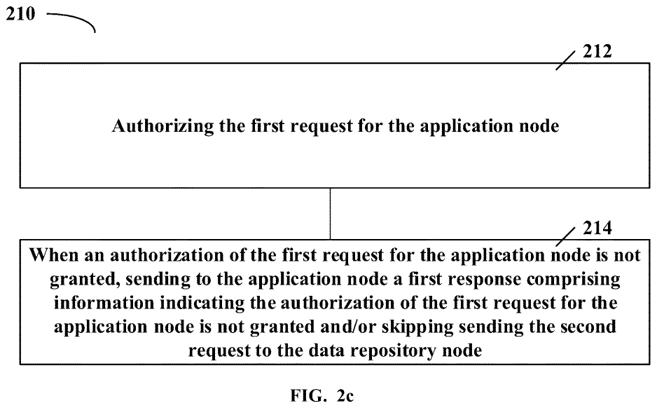

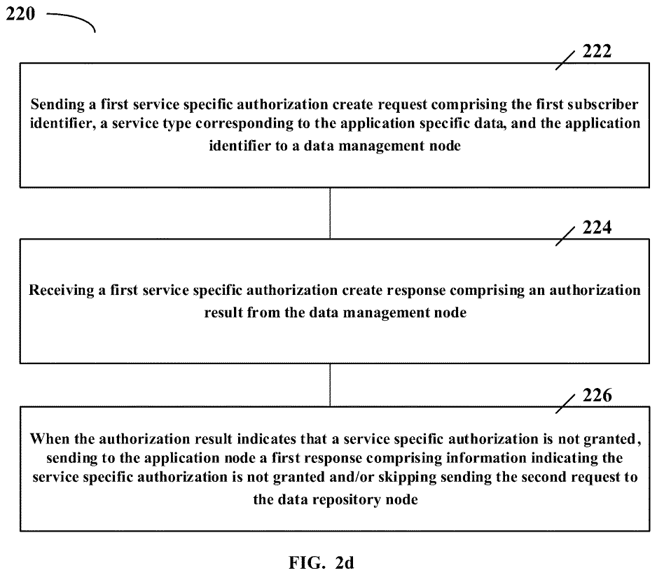

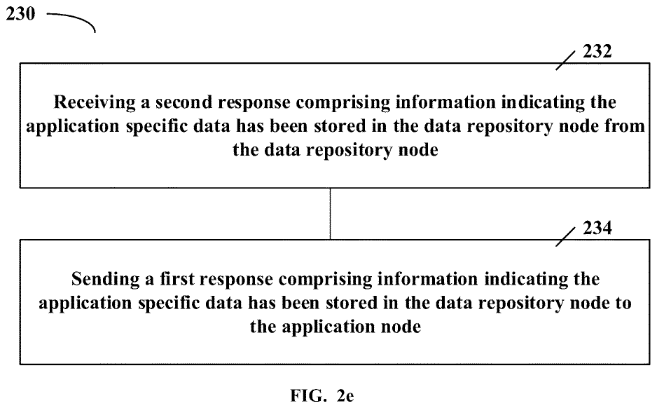

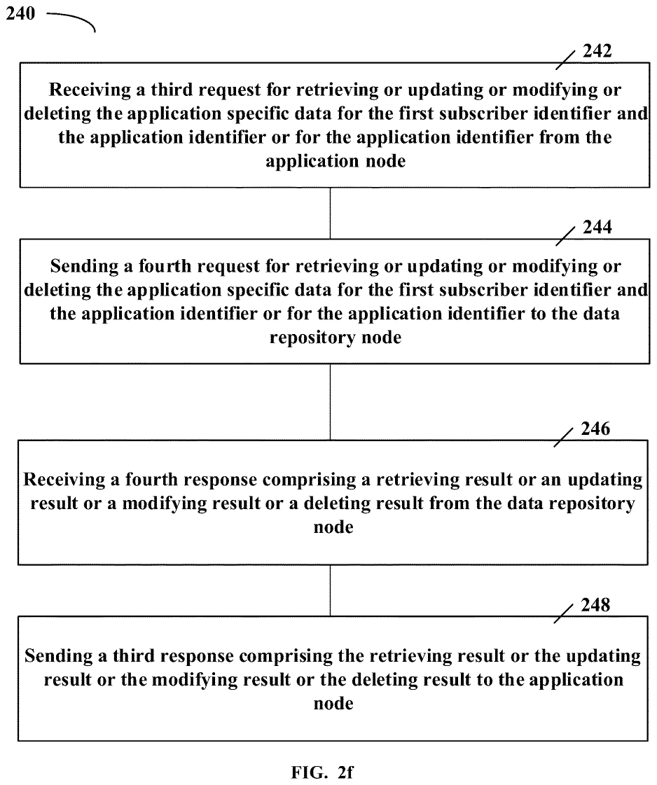

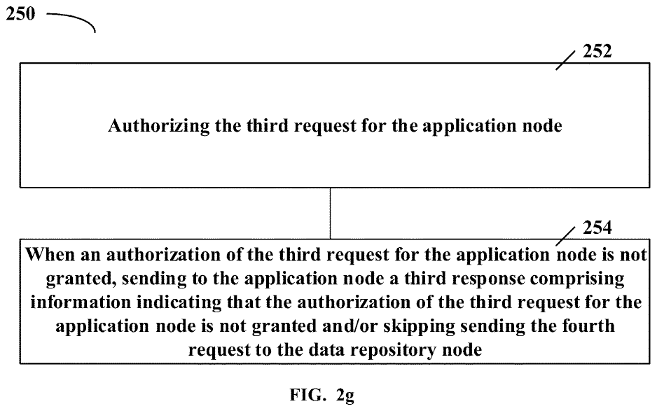

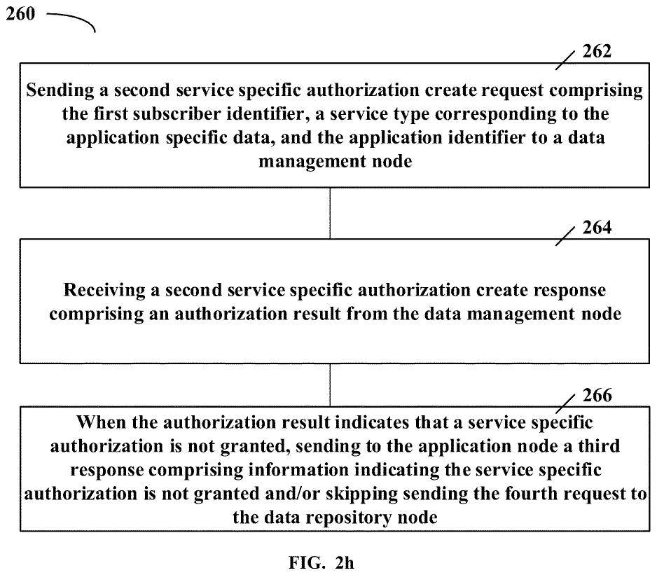

FIG. 2a shows a flowchart of a method according to an embodiment of the present disclosure, which may be performed by an apparatus implemented in or at or as an exposure function node or communicatively coupled to the exposure function node. As such, the apparatus may provide means or modules for accomplishing various parts of the method 200 as well as means or modules for accomplishing other processes in conjunction with other components.

The exposure function node may be any suitable network function which can implement network exposure function and/or service capability exposure function.

In an embodiment, the exposure function node may comprise at least one of a SCEF, a NEF, or a combined SCEF and NEF for example as shown in FIGS. 1a, 1b and 1c.

At block 202, the exposure function node may receive a first request comprising application specific data (ASD), an application identifier, a first subscriber identifier from an application node.

The application node may be any suitable server or function in which various types of applications can be installed. In an embodiment, the application node comprises at least one of AS, SCS, or AF for example as shown in FIGS. 1a, 1b and 1c.

The first request may be any suitable message such as existing message or new message which can enable the application node to store the application specific data in a storage of MNO via the exposure function node.

In an embodiment, the first request may comprise at least one of a service parameter create request or an application specific data storage create request.

For example, the service parameter create request may be used to store the application specific data in a storage of MNO via the exposure function node. The service parameter create request may be similar to the Nnef_ServiceParameter_Create request as described in 3GPP TS 23.502 V18.0.0, the disclosure of which is incorporated by reference herein in its entirety.

For example, the application specific data storage create request may be used to store the application specific data in a storage of MNO via the exposure function node.

The application specific data may be any suitable data related to the application. In an embodiment, the application specific data may comprise information in a form of attribute and value pairs. For example, the application specific data may include information in the form of attribute/value pairs, e.g. application-premium (attribute): TRUE (value) and username (attribute): bob_alice (value), etc.

The application specific data may be of any suitable form. For example, the ASD may have an open format as described in 3GPP TS 29.519 V17.8.0. In an embodiment, The format of the application specific data may be similar to existing operator-specific-data (OSD) format as described in 3GPP TS 29.519 V17.8.0.

FIG. 2b shows a new resource model for the ASD in unified data repository (UDR) according to an embodiment of the present disclosure. As shown the new resource model for ASD may comprise ASD, application identifier (appId) and user equipment ID (ueId).

Note that any other suitable resource model for the ASD may be defined and the present disclosure has no limit on it.

The application identifier may contain the information of the application identifier which can be used to identifies an application.

The ueId may represent a subscription identifier such as Subscription Permanent Identifier (SUPI) or Generic Public Subscription Identifier (GPSI), etc.

In an embodiment, the appId and ueId may be similar to the appId and ueId as described in 3GPP TS 29.519 V17.8.0.

Table 1 provides an example of the resources and applicable Hyper Text Transfer Protocol (HTTP) methods for the ASD.

TABLE 1

| | | HTTP method or | |
|---|---|---|---|
| Resource name | Resource URI | custom operation | Description |
| application specific | /application-data/asd/{appId} | GET | Retrieve complete ASD (for all |
| data | | | subscribers) |
| Individual ASD | /application-data/asd/ | GET | Retrieve ASD for the specified application |
| | {appId} {ueId} | | identifier and UE |
| | | DELETE | Delete ASD for the specified application |
| | | | identifier and UE |
| | | PUT | Create or update ASD for the specified |
| | | | application identifier and UE |
| | | PATCH | Modify ASD for the specified application |
| | | | identifier and UE |

Note that any other suitable resource name and HTTP methods may be defined and the present disclosure has no limit on it.

In an embodiment, an access to the application specific data may be only offered to an application managing the application specific data. For example, the ASD may be keyed/accessed by using the application identifier and/or the first subscriber identifier such as MSISDN.

The first subscriber identifier may be any suitable identifier. For example, the first subscriber identifier may be allocated by MNO. In an embodiment, the first subscriber identifier may comprise at least one of a mobile subscriber integrated services digital network number (MSISDN) or an external identifier.

In an embodiment, the first subscriber identifier may be Generic Public Subscription Identifier (GPSI). GPSI may be needed for addressing a 3GPP subscription in different data networks outside of the 3GPP system. The 3GPP system stores within the subscription data the association between the GPSI and the corresponding SUPI. GPSIs are public identifiers used both inside and outside of the 3GPP system. The GPSI is either an MSISDN or an External Identifier, as described in 3GPP TS 23.003 V18.0.0, the disclosure of which is incorporated by reference herein in its entirety. If MSISDN is included in the subscription data, it shall be possible that the same MSISDN value is supported in both 5GS and EPS. There is no implied 1-to-1 relationship between GPSI and SUPI.

For example, as described in 3GPP TS 23.003 V18.0.0, an External Identifier identifies a subscription associated to an IMSI (International Mobile Subscriber Identity). A subscription associated to an IMSI may have one or several External Identifier(s). The External Identifier shall have the form username@realm as specified in clause 2.1 of Internet Engineering Task Force (IETF) Request For Comments (RFC) 4282. The username part format of the External Identifier shall contain a Local Identifier as specified in 3GPP TS 23.682 V17.3.0. The realm part format of the External Identifier shall contain a Domain Identifier as specified in 3GPP TS 23.682 V17.3.0. As specified in clause 4 of IETF RFC 4282, the Domain Identifier shall be a duly registered Internet domain name. The combination of Local Identifier and Domain Identifier makes the External Identifier globally unique.

The result of the External Identifier form is:
“<Local Identifier>@<Domain Identifier>”

An example of an External Identifier is:
Local Identifier in use: “123456789”;
Domain Identifier=“domain.com”;

Which gives the External Identifier as:
123456789@domain.com.

At block 204, the exposure function node may send a second request comprising the application specific data, the application identifier, the first subscriber identifier or a second identifier associated to the first subscriber identifier to a data repository node.

The data repository node may be any suitable network function which can provide data storage function. In an embodiment, the data repository node may comprise at least one of a home subscriber server (HSS) or a unified data repository (UDR) for example as shown in FIGS. 1a and 1d.

The second request may be any suitable message. For example, the second request may be used for storing the ASD in a storage of MNO. In an embodiment, the second request comprises at least one of a data management create request. The data management create request may be used to store ASD into the data repository node such as UDR. For example, the data management create request may be similar to Nudr_DM_Create request as described in 3GPP TS 23.502 V18.0.0.

The second identifier may be any suitable identifier. For example, the second identifier may be allocated by the MNO. In an embodiment, the second identifier may comprise a user equipment identifier. The user equipment identifier may represent the subscription identifier such as SUPI or GPSI. In an embodiment, the user equipment identifier may be similar to the UE ID or ueId as described in 3GPP TS 23.502 V18.0.0 and 3GPP TS 29.519 V17.8.0.

In an embodiment, the user equipment identifier may comprise at least one of an international mobile subscription identity (IMSI) or a subscription permanent identifier (SUPI).

The user equipment identifier may be obtained in various ways. For example, the exposure function node may invoke identifier translation service to resolve the first subscriber identifier such as GPSI to the second identifier such as SUPI. For example, the NEF can invoke Nudm SDM Get (Identifier Translation, GPSI and AF Identifier) to resolve the GPSI to SUPI.

FIG. 2c shows a flowchart of a method according to another embodiment of the present disclosure, which may be performed by an apparatus implemented in or at or as an exposure function node or communicatively coupled to the exposure function node. As such, the apparatus may provide means or modules for accomplishing various parts of the method 210 as well as means or modules for accomplishing other processes in conjunction with other components. For some parts which have been described in the above embodiments, the description thereof is omitted here for brevity.

At block 212, the exposure function node may authorize the first request for the application node. For example, the exposure function node may check whether the application node is authorized to send the first request.

In an embodiment, block 212 may be performed immediately after block 202 of FIG. 2a.

At block 214, when an authorization of the first request for the application node is not granted, the exposure function node may send to the application node a first response comprising information indicating the authorization of the first request for the application node is not granted and/or skip sending the second request to the data repository node.

In an embodiment, when the authorization of the first request for the application node is granted, the method may continue with other steps.

FIG. 2d shows a flowchart of a method according to another embodiment of the present disclosure, which may be performed by an apparatus implemented in or at or as an exposure function node or communicatively coupled to the exposure function node. As such, the apparatus may provide means or modules for accomplishing various parts of the method 220 as well as means or modules for accomplishing other processes in conjunction with other components. For some parts which have been described in the above embodiments, the description thereof is omitted here for brevity.

At block 222, the exposure function node may send a first service specific authorization create request comprising the first subscriber identifier, a service type corresponding to the application specific data, and the application identifier to a data management node.

The first service specific authorization create request may be used to request authorization for a specific service configuration.

In an embodiment, the first service specific authorization create request may be similar to Nudm_ServiceSpecificAuthorisation_Create request as described in 3GPP TS 23.502 V18.0.0.

At block 224, the exposure function node may receive a first service specific authorization create response comprising an authorization result from the data management node.

In an embodiment, the first service specific authorization create response may be similar to Nudm_ServiceSpecificAuthorisation_Create response as described in 3GPP TS 23.502 V18.0.0.

At block 226, when the authorization result indicates that a service specific authorization is not granted, the exposure function node may send to the application node a first response comprising information indicating the service specific authorization is not granted and/or skip sending the second request to the data repository node.

In an embodiment, when the authorization result indicates that the service specific authorization is granted, the method may continue with other steps.

FIG. 2e shows a flowchart of a method according to another embodiment of the present disclosure, which may be performed by an apparatus implemented in or at or as an exposure function node or communicatively coupled to the exposure function node. As such, the apparatus may provide means or modules for accomplishing various parts of the method 230 as well as means or modules for accomplishing other processes in conjunction with other components. For some parts which have been described in the above embodiments, the description thereof is omitted here for brevity.

At block 232, the exposure function node may receive a second response comprising information indicating the application specific data has been stored in the data repository node from the data repository node.

At block 234, the exposure function node may send a first response comprising information indicating the application specific data has been stored in the data repository node to the application node.

FIG. 2f shows a flowchart of a method according to another embodiment of the present disclosure, which may be performed by an apparatus implemented in or at or as an exposure function node or communicatively coupled to the exposure function node. As such, the apparatus may provide means or modules for accomplishing various parts of the method 240 as well as means or modules for accomplishing other processes in conjunction with other components. For some parts which have been described in the above embodiments, the description thereof is omitted here for brevity.

At block 242, the exposure function node may receive a third request for retrieving or updating or modifying or deleting the application specific data for the first subscriber identifier and the application identifier or for the application identifier from the application node.

The third request may be any suitable request such as new request or existing request. In an embodiment, the third request comprises at least one of a service parameter get request, an application specific data get request, a service parameter update request, an application specific data storage update request, a service parameter modification request, an application specific data storage modification request, a service parameter delete request, or an application specific data delete request.

For example, the service parameter update request or the service parameter modification request may be used to update or modify the application specific data in the data repository node via the exposure function node. The service parameter update request or the service parameter modification request may be similar to the Nnef_ServiceParameter_Update request as described in 3GPP TS 23.502 V18.0.0.

For example, the application specific data storage update request or the application specific data storage modification request may be used to update or modify the application specific data in the data repository node via the exposure function node.

For example, the service parameter get request and application specific data get request may be used to retrieve or get the application specific data for the first subscriber identifier and the application identifier or for the application identifier. The service parameter get request may be similar to Nnef_ServiceParameter_Get request as described in 3GPP TS 23.502 V18.0.0.

For example, the service parameter delete request and application specific data delete request may be used to delete the application specific data for the first subscriber identifier and the application identifier or for the application identifier. The service parameter delete request may be similar to Nnef_ServiceParameter_delete request as described in 3GPP TS 23.502 V18.0.0.

At block 244, the exposure function node may send a fourth request for retrieving or updating or modifying or deleting the application specific data for the first subscriber identifier and the application identifier or for the application identifier to the data repository node.

The fourth request may be any suitable request such as new request or existing request. In an embodiment, the fourth request comprises a data management query request, a data management update request, or a data management delete request.

For example, the data management query request may be used to retrieve or get the application specific data for the first subscriber identifier and the application identifier or for the application identifier. The data management query request may be similar to Nudr_DM_Query request as described in 3GPP TS 23.502 V18.0.0.

For example, the data management update request may be used to update or modify the application specific data for the first subscriber identifier and the application identifier or for the application identifier. The data management update request may be similar to Nudr_DM_update request as described in 3GPP TS 23.502 V18.0.0.

For example, the data management delete request may be used to delete the application specific data for the first subscriber identifier and the application identifier or for the application identifier. The data management delete request may be similar to Nudr_DM_delete request as described in 3GPP TS 23.502 V18.0.0.

At block 246, the exposure function node may receive a fourth response comprising a retrieving result or an updating result or a modifying result or a deleting result from the data repository node.

The fourth response may be any suitable response such as new response or existing response. In an embodiment, the fourth response comprises a data management query response, a data management update response, or a data management delete response.

For example, the data management query response may be similar to Nudr_DM_Query response as described in 3GPP TS 23.502 V18.0.0. The data management update response may be similar to Nudr_DM_update response as described in 3GPP TS 23.502 V18.0.0. The data management delete response may be similar to Nudr_DM_delete response as described in 3GPP TS 23.502 V18.0.0.

At block 248, the exposure function node may send a third response comprising the retrieving result or the updating result or the modifying result or the deleting result to the application node.

The third response may be any suitable request such as new response or existing response. In an embodiment, the third response comprises at least one of a service parameter get response, an application specific data get response, a service parameter update response, an application specific data storage update response, a service parameter modification response, an application specific data storage modification response, a service parameter delete request, or an application specific data delete response.

For example, the service parameter update response or the service parameter modification response may be similar to the Nnef_ServiceParameter_Update request as described in 3GPP TS 23.502 V18.0.0.

For example, the service parameter get response may be similar to Nnef_ServiceParameter_Get request as described in 3GPP TS 23.502 V18.0.0.

For example, the service parameter delete response may be similar to Nnef_ServiceParameter_delete response as described in 3GPP TS 23.502 V18.0.0.

FIG. 2g shows a flowchart of a method according to another embodiment of the present disclosure, which may be performed by an apparatus implemented in or at or as an exposure function node or communicatively coupled to the exposure function node. As such, the apparatus may provide means or modules for accomplishing various parts of the method 250 as well as means or modules for accomplishing other processes in conjunction with other components. For some parts which have been described in the above embodiments, the description thereof is omitted here for brevity.

At block 252, the exposure function node may authorize the third request for the application node.

For example, the exposure function node may check whether the application node is authorized to send the third request.

In an embodiment, block 252 may be performed immediately after block 242 of FIG. 2f.

At block 254, when an authorization of the third request for the application node is not granted, the exposure function node may send to the application node a third response comprising information indicating that the authorization of the third request for the application node is not granted and/or skip sending the fourth request to the data repository node.

In an embodiment, when the authorization of the third request for the application node is granted, the method may continue with other steps.

FIG. 2h shows a flowchart of a method according to another embodiment of the present disclosure, which may be performed by an apparatus implemented in or at or as an exposure function node or communicatively coupled to the exposure function node. As such, the apparatus may provide means or modules for accomplishing various parts of the method 260 as well as means or modules for accomplishing other processes in conjunction with other components. For some parts which have been described in the above embodiments, the description thereof is omitted here for brevity.

At block 262, the exposure function node may send a second service specific authorization create request comprising the first subscriber identifier, a service type corresponding to the application specific data, and the application identifier to a data management node.

The second service specific authorization create request may be used to request authorization for a specific service configuration.

In an embodiment, the second service specific authorization create request may be similar to Nudm_ServiceSpecificAuthorisation_Create request as described in 3GPP TS 23.502 V18.0.0.

At block 264, the exposure function node may receive a second service specific authorization create response comprising an authorization result from the data management node.

In an embodiment, the second service specific authorization create response may be similar to Nudm_ServiceSpecificAuthorisation_Create response as described in 3GPP TS 23.502 V18.0.0.

At block 266, when the authorization result indicates that a service specific authorization is not granted, the exposure function node may send to the application node a third response comprising information indicating the service specific authorization is not granted and/or skip sending the fourth request to the data repository node.

In an embodiment, when the authorization result indicates that the service specific authorization is granted, the method may continue with other steps.

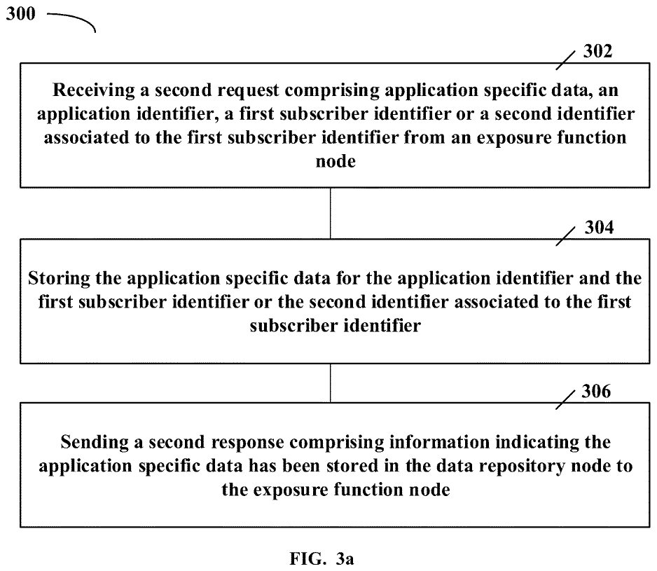

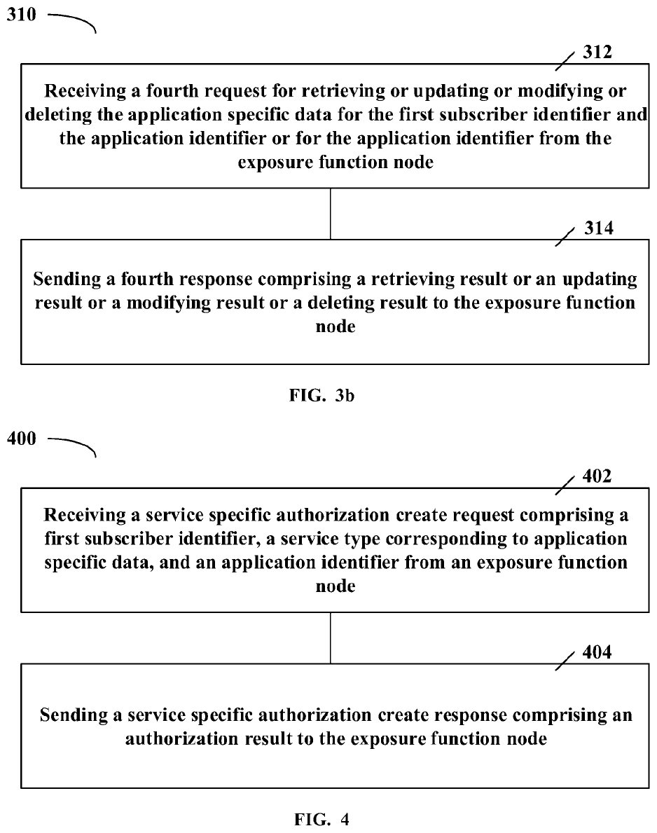

FIG. 3a shows a flowchart of a method according to another embodiment of the present disclosure, which may be performed by an apparatus implemented in or at or as a data repository node or communicatively coupled to the data repository node. As such, the apparatus may provide means or modules for accomplishing various parts of the method 300 as well as means or modules for accomplishing other processes in conjunction with other components. For some parts which have been described in the above embodiments, the description thereof is omitted here for brevity.

At block 302, the data repository node may receive a second request comprising application specific data, an application identifier, a first subscriber identifier or a second identifier associated to the first subscriber identifier from an exposure function node.

At block 304, the data repository node may store the application specific data for the application identifier and the first subscriber identifier or the second identifier associated to the first subscriber identifier.

At block 306, the data repository node may send a second response comprising information indicating the application specific data has been stored in the data repository node to the exposure function node.

In an embodiment, the exposure function node may comprise at least one of a service capability exposure function (SCEF) a network exposure function (NEF) or a combined SCEF and NEF.

In an embodiment, the data repository node may comprise at least one of a home subscriber server (HSS) or a unified data repository (UDR).

In an embodiment, the second request may comprise a data management create request.

In an embodiment, an access to the application specific data may be only offered to an application managing the application specific data.

In an embodiment, the application specific data may comprise information in a form of attribute and value pairs.

In an embodiment, the first subscriber identifier may comprise at least one of a mobile subscriber integrated services digital network number (MSISDN) or an external identifier.

In an embodiment, the second identifier may comprise a user equipment identifier.

In an embodiment, the user equipment identifier may comprise at least one of an international mobile subscription identity (IMSI) or a subscription permanent identifier (SUPI).

FIG. 3b shows a flowchart of a method according to another embodiment of the present disclosure, which may be performed by an apparatus implemented in or at or as a data repository node or communicatively coupled to the data repository node. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the data repository node may receive a fourth request for retrieving or updating or modifying or deleting the application specific data for the first subscriber identifier and the application identifier or for the application identifier from the exposure function node.

For example, after receiving the fourth request, the data repository node may perform a corresponding operation and generate retrieving result or an updating result or a modifying result or a deleting result.

At block 314, the data repository node may send a fourth response comprising a retrieving result or an updating result or a modifying result or a deleting result to the exposure function node.

In an embodiment, the fourth request may comprise at least one of a data management query request a data management update request or a data management delete request.

In an embodiment, the fourth response may comprise at least one of a data management query response, a data management update response or a data management delete response.

FIG. 4 shows a flowchart of a method according to another embodiment of the present disclosure, which may be performed by an apparatus implemented in or at or as a data management node or communicatively coupled to the data management node. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the data management node may receive a service specific authorization create request comprising a first subscriber identifier, a service type corresponding to application specific data, and an application identifier from an exposure function node.

For example, after receiving the service specific authorization create request, the data management node may perform authorization operation and generate an authorization result.

At block 404, the data management node may send a service specific authorization create response comprising an authorization result to the exposure function node.

In an embodiment, an access to the application specific data is only offered to an application managing the application specific data.

In an embodiment, the application specific data comprises information in a form of attribute and value pairs.

In an embodiment, the first subscriber identifier comprises at least one of a mobile subscriber integrated services digital network number (MSISDN) or an external identifier.

In an embodiment, the exposure function node comprises at least one of a service capability exposure function (SCEF), a network exposure function (NEF) or a combined SCEF and NEF.

In an embodiment, the data management node comprises at least one of a home subscriber server (HSS) or a Unified Data Management (UDM).

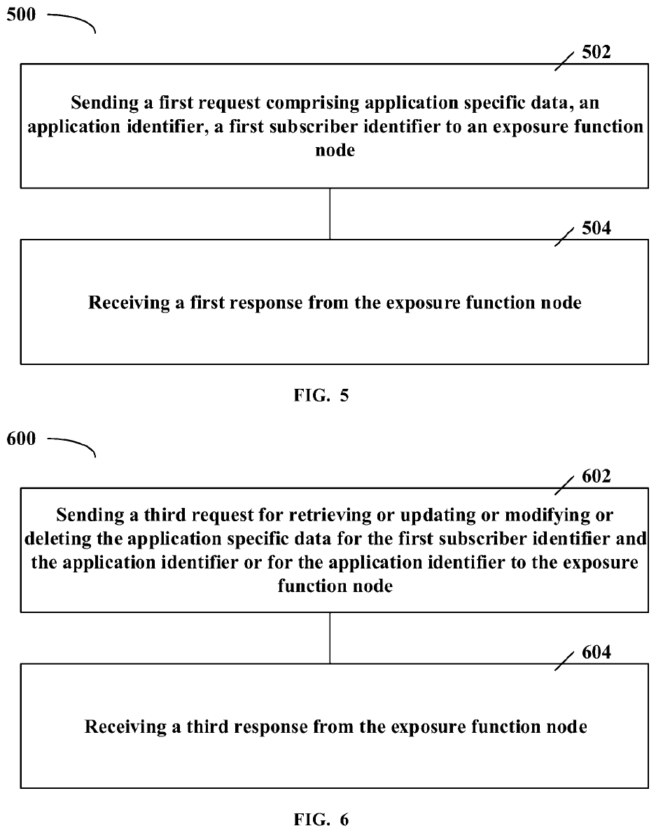

FIG. 5 shows a flowchart of a method according to another embodiment of the present disclosure, which may be performed by an apparatus implemented in or at or as an application node or communicatively coupled to the application node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the application node may send a first request comprising application specific data, an application identifier, a first subscriber identifier to an exposure function node.

At block 504, the application node may receive a first response from the exposure function node.

In an embodiment, the exposure function node comprises at least one of a service capability exposure function (SCEF), a network exposure function (NEF), or a combined SCEF and NEF.

In an embodiment, the application node comprises at least one of an application servers (AS), a services capability server (SCS), or an application function (AF).

In an embodiment, the first request comprises at least one of a service parameter create request, or an application specific data storage create request.

In an embodiment, an access to the application specific data is only offered to an application managing the application specific data.

In an embodiment, the application specific data comprises information in a form of attribute and value pairs.

In an embodiment, the first subscriber identifier comprises at least one of a mobile subscriber integrated services digital network number (MSISDN), or an external identifier.

In an embodiment, the first response comprises at least one of information indicating an authorization of the first request for the application node is not granted, information indicating a service specific authorization is not granted, or information indicating the application specific data has been stored in a data repository node.

In an embodiment, when the first response comprises the information indicating the service specific authorization is not granted, it may indicate that an association of a network operator subscription of a user and an application subscription of the user is not valid.

In an embodiment, when the first response comprises the information indicating the application specific data has been stored in a data repository node, it may indicate that an association of a network operator subscription of a user and an application subscription of the user is valid.

With these embodiments, the linkage of the application entitlement/subscription (e.g. application account) and the MNO subscription may be obtained.

FIG. 6 shows a flowchart of a method according to another embodiment of the present disclosure, which may be performed by an apparatus implemented in or at or as an application node or communicatively coupled to the application node. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the application node may send a third request for retrieving or updating or modifying or deleting the application specific data for the first subscriber identifier and the application identifier or for the application identifier to the exposure function node.

At block 604, the application node may receive a third response from the exposure function node.

In an embodiment, the third request may comprise at least one of a service parameter get request, an application specific data get request, a service parameter update request, an application specific data storage update request, a service parameter modification request, an application specific data storage modification request, a service parameter delete request, or an application specific data delete request.

In an embodiment, the third response comprises at least one of a retrieving result, an updating result, a modifying result, a deleting result, information indicating an authorization of the third request for the application node is not granted, or information indicating a service specific authorization is not granted.

In an embodiment, when the third response comprises the information indicating the service specific authorization is not granted, it may indicate that an association of a network operator subscription of a user and an application subscription of the user is not valid.

In an embodiment, when the third response comprises the application specific data for the first subscriber identifier and the application identifier, it may indicate that an association of a network operator subscription of a user and an application subscription of the user is valid.

With these embodiments, the linkage of the application entitlement/subscription (e.g. application account) and the MNO subscription may be obtained.

In an embodiment, it may extend NEF Service Parameter API to accommodate ASD service requirements. For example, Service Parameter API of 3GPP TS 29.522 V18.0.0, the disclosure of which is incorporated by reference herein in its entirety, may include a new object/data type Application-Specific-Data (ASD). This ASD may have an open format (similar to existing operator-specific-data/OSD format) in 3GPP TS 29.519 V17.8.0, but the access to this ASD may be only offered to the Application managing the ASD.

In an embodiment, such open format of ASD may allow the application to include information in the form of attribute/value pairs, e.g. application-premium (attribute): TRUE (value) & username (attribute): bob_alice (value), etc.

In an embodiment, in addition to authorize the application to call/invoke the Service Parameter API or application specific data storage API, NEF may authorize the service requested (ASD) on the target UE via UDM. This may be done by defining a new service type (ASD) in Service Specific Authorization (nudm-ssau service) as defined in 3GPP TS 29.503 V18.0.0, the disclosure of which is incorporated by reference herein in its entirety.

In an embodiment, Service Parameter API in NEF may be extended to allow applications to store and query Application Specific Data (ASD) in an open/flexible and extensible format in 5GC central repository (e.g., UDR) to offer the redundancy, persistency, high availability (e.g. via data replication and/or distributed database) of such data in mobile network.

FIG. 7 shows a flowchart of a method according to another embodiment of the present disclosure.

Steps 1-6 are used for storing ASD.
Step 1. AF/Application (App) sends an Nnef_ServiceParameter_Create request (MSISDN, ASD with App subscription=true, AF ID) to NEF. For example, AF calls Service Parameter API and includes Application Specific Data (ASD) with a list of attribute names and its values (in this example, App subscription=true). As an alternative, a new API can be defined (e.g. AppSpecificStorage) so that Apps may simply use the 5GC network as a data repository (strictly related to Apps, not to the 5G Core Network).
Step 2. NEF sends an Nudm_ServiceSpecificAuthorisation_Create request (MSISDN, service type=ASD, AF ID) to UDM. For example, NEF authorizes the API for the requesting AF and calls API Service Specific Authorization with a new service type value (ASD) so that UDM authorizes ASD for the requested UE and requesting AF.
Step 3. NEF receives an Nudm_ServiceSpecificAuthorisation_Create response (OK) from UDM. For example, when authorization is OK (note: interaction between UDM/UDR to retrieve authorization data for new ASD service type is not shown in the flow), UDM responds successfully to NEF.
Step 4. NEF sends an Nudr_DM_Create request (ueId, ASD with App subscription=true, AF ID) to UDR. For example, NEF creates ASD in UDR using a new resource structure as shown in FIG. 2b.
Step 5. NEF receives an Nudr_DM_Create response (OK) from UDR. In this example, UDR responds successfully.
Step 6. NEF sends an Nnef_ServiceParameter_Create response (OK) to AF/App. In this example, NEF responds successfully.
Steps 7-12 are used for retrieving ASD. The flow of ASD retrieval is similar to the flow of storing ASD. The HTTP URI in this case includes a different path as shown in FIG. 2b, such as HTTP GET . . . /application-data/asd/appId/ueId or HTTP GET . . . /application-data/asd/appId/or HTTP GET . . . /application-data/asd/appId?ueId=xxx, etc.
Step 7. AF/App sends an Nnef_ServiceParameter_get request (MSISDN, ASD indication, AF ID) to NEF.
Step 8. NEF sends an Nudm_ServiceSpecificAuthorisation_Create request (MSISDN, service type=ASD, AF ID) to UDM.
Step 9. NEF receives an Nudm_ServiceSpecificAuthorisation_Create response (OK) from UDM. For example,
Step 10. NEF sends an Nudr_DM_Query request (ueId, ASD indication, AF ID) to UDR.
Step 11. NEF receives an Nudr_DM_Query response (ASD with App subscription=true) from UDR.
Step 12. NEF sends an Nnef_ServiceParameter_get response (ASD with App subscription=true) to AF/App.

The messages of FIG. 7 may be similar to the corresponding messages as described in various 3GPP specifications such as 3GPP TS 23.502 V18.0.0 except that they are enhanced for ASD service.

Embodiments herein may provide many advantages, of which a non-exhaustive list of examples follows. In some embodiments herein, it may allow applications to use the MNO's network in a sort of Storage as a Service (Saas) by exposing (via API) the reliability and robustness of the network (e.g., 5GS) subscription data repository (e.g., UDR). In some embodiments herein, applications no longer require a local storage and a synchronization of the MNO subscription and the application's account, since the ASD is keyed/accessed by using directly the subscriber identifier such as MSISDN. In some embodiments herein, it may allow applications to store and query ASD in an open/flexible and extensible format in MNO's central repository (e.g., UDR) to offer the redundancy, persistency, high availability (e.g. via data replication and/or distributed database) of ASD data in MNO network. The embodiments herein are not limited to the features and advantages mentioned above. A person skilled in the art will recognize additional features and advantages upon reading the following detailed description.

The proposed solution may be of interest for MNO and application provider (e.g., AF). For example, the AF may be able to define what parameter they want to search for, and this parameter may be only known and used by AF. E.g., application can check for subscriber with MSISDN if the application_subscription is set as TRUE. MNO may use its core network as a central repository for these types of entitlement. MNO has an entitlement server, but the AF cannot access this server directly.

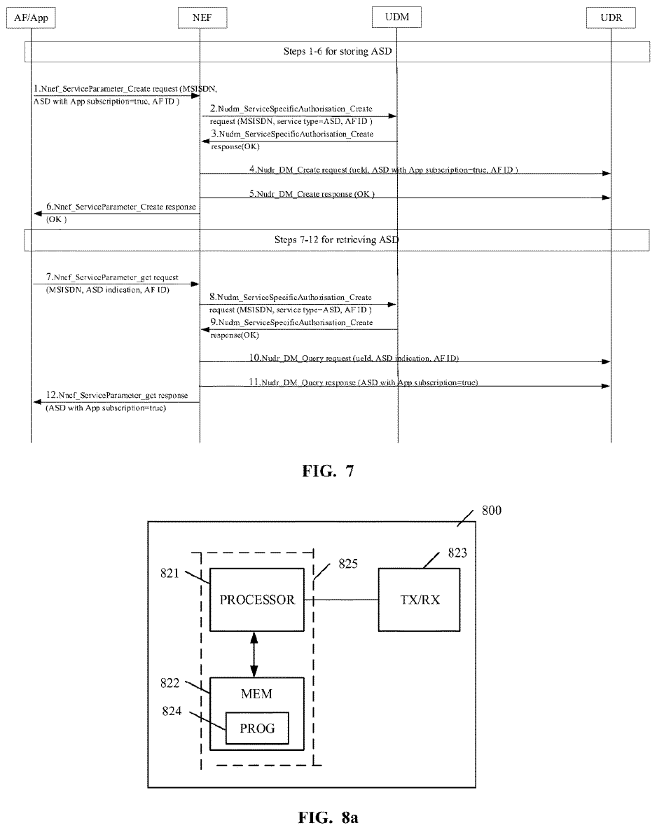

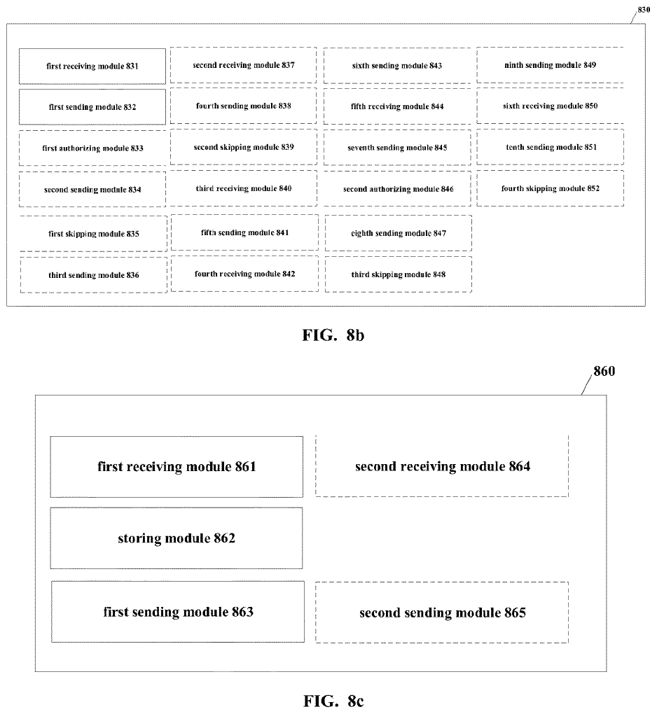

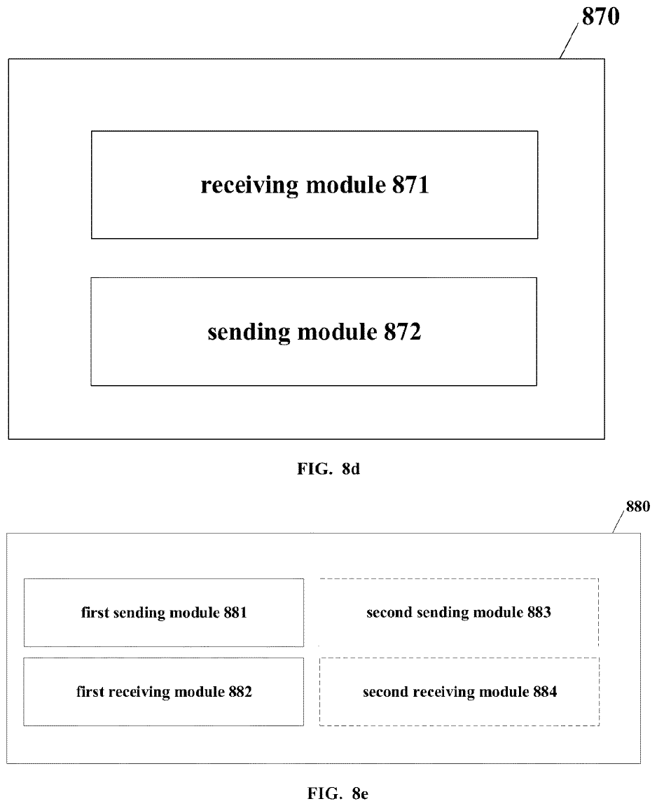

FIG. 8a is a block diagram showing an apparatus suitable for practicing some embodiments of the disclosure. For example, the exposure function node, the data repository node, the data management node or the application node described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the exposure function node, the memory 822 contains instructions executable by the processor 821, whereby the exposure function node operates according to any of the methods related to the exposure function node as described above.

In an embodiment where the apparatus is implemented as or at the data repository node, the memory 822 contains instructions executable by the processor 821, whereby the data repository node operates according to any of the methods related to the data repository node as described above.

In an embodiment where the apparatus is implemented as or at the data management node, the memory 822 contains instructions executable by the processor 821, whereby the data management node operates according to any of the methods related to the data management node as described above.

In an embodiment where the apparatus is implemented as or at the application node, the memory 822 contains instructions executable by the processor 821, whereby the application node operates according to any of the methods related to the application node as described above.

FIG. 8b is a block diagram showing an exposure function node according to an embodiment of the disclosure. As shown, the exposure function node 830 comprises a first receiving module 831 configured to receive a first request comprising application specific data, an application identifier, a first subscriber identifier from an application node. The exposure function node 830 further comprises a first sending module 832 configured to send a second request comprising the application specific data, the application identifier, the first subscriber identifier or a second identifier associated to the first subscriber identifier to a data repository node.

In an embodiment, the exposure function node 830 further comprises a first authorizing module 833 configured to authorize the first request for the application node.

In an embodiment, the exposure function node 830 further comprises a second sending module 834 configured to, when an authorization of the first request for the application node is not granted, send to the application node a first response comprising information indicating the authorization of the first request for the application node is not granted.

In an embodiment, the exposure function node 830 further comprises a first skipping module 835 configured to, when an authorization of the first request for the application node is not granted, skip sending the second request to the data repository node.

In an embodiment, the exposure function node 830 further comprises a third sending module 836 configured to send a first service specific authorization create request comprising the first subscriber identifier, a service type corresponding to the application specific data, and the application identifier to a data management node.

In an embodiment, the exposure function node 830 further comprises a second receiving module 837 configured to receive a first service specific authorization create response comprising an authorization result from the data management node.

In an embodiment, the exposure function node 830 further comprises a fourth sending module 838 configured to, when the authorization result indicates that a service specific authorization is not granted, send to the application node a first response comprising information indicating the service specific authorization is not granted.

In an embodiment, the exposure function node 830 further comprises a second skipping module 839 configured to, when the authorization result indicates that a service specific authorization is not granted, skip sending the second request to the data repository node.

In an embodiment, the exposure function node 830 further comprises a third receiving module 840 configured to receive a second response comprising information indicating the application specific data has been stored in the data repository node from the data repository node.

In an embodiment, the exposure function node 830 further comprises a fifth sending module 841 configured to send a first response comprising information indicating the application specific data has been stored in the data repository node to the application node.

In an embodiment, the exposure function node 830 further comprises a fourth receiving module 842 configured to receive a third request for retrieving or updating or modifying or deleting the application specific data for the first subscriber identifier and the application identifier or for the application identifier from the application node.

In an embodiment, the exposure function node 830 further comprises a sixth sending module 843 configured to send a fourth request for retrieving or updating or modifying or deleting the application specific data for the first subscriber identifier and the application identifier or for the application identifier to the data repository node.

In an embodiment, the exposure function node 830 further comprises a fifth receiving module 844 configured to receive a fourth response comprising a retrieving result or an updating result or a modifying result or a deleting result from the data repository node.

In an embodiment, the exposure function node 830 further comprises a seventh sending module 845 configured to send a third response comprising the retrieving result or the updating result or the modifying result or the deleting result to the application node.

In an embodiment, the exposure function node 830 further comprises a second authorizing module 846 configured to authorize the third request for the application node.

In an embodiment, the exposure function node 830 further comprises an eighth sending module 847 configured to, when an authorization of the third request for the application node is not granted, send to the application node a third response comprising information indicating that the authorization of the third request for the application node is not granted.

In an embodiment, the exposure function node 830 further comprises a third skipping module 848 configured to, when an authorization of the third request for the application node is not granted, skip sending the fourth request to the data repository node.

In an embodiment, the exposure function node 830 further comprises a ninth sending module 849 configured to send a second service specific authorization create request comprising the first subscriber identifier, a service type corresponding to the application specific data, and the application identifier to a data management node.

In an embodiment, the exposure function node 830 further comprises a sixth receiving module 850 configured to receive a second service specific authorization create response comprising an authorization result from the data management node.

In an embodiment, the exposure function node 830 further comprises a tenth sending module 851 configured to, when the authorization result indicates that a service specific authorization is not granted, send to the application node a third response comprising information indicating the service specific authorization is not granted.

In an embodiment, the exposure function node 830 further comprises a fourth skipping module 852 configured to, when the authorization result indicates that a service specific authorization is not granted, skip sending the fourth request to the data repository node.

FIG. 8c is a block diagram showing a data repository node according to an embodiment of the disclosure. As shown, the data repository node 860 comprises a first receiving module 861 configured to receive a second request comprising application specific data, an application identifier, a first subscriber identifier or a second identifier associated to the first subscriber identifier from an exposure function node. The data repository node 860 further comprises a storing module 862 configured to store the application specific data for the application identifier and the first subscriber identifier or the second identifier associated to the first subscriber identifier. The data repository node 860 further comprises a first sending module 863 configured to send a second response comprising information indicating the application specific data has been stored in the data repository node to the exposure function node.

In an embodiment, the data repository node 860 further comprises a second receiving module 864 configured to receive a fourth request for retrieving or updating or modifying or deleting the application specific data for the first subscriber identifier and the application identifier or for the application identifier from the exposure function node.

In an embodiment, the data repository node 860 further comprises a second sending module 865 configured to send a fourth response comprising a retrieving result or an updating result or a modifying result or a deleting result to the exposure function node.

FIG. 8d is a block diagram showing a data management node according to another embodiment of the disclosure. As shown, the data management node 870 comprises a receiving module 871 configured to receive a service specific authorization create request comprising a first subscriber identifier, a service type corresponding to application specific data, and an application identifier from an exposure function node. The data management node 870 further comprises a sending module 872 configured to send a service specific authorization create response comprising an authorization result to the exposure function node.

FIG. 8e is a block diagram showing an application node according to another embodiment of the disclosure. As shown, the application node 880 comprises a first sending module 881 configured to send a first request comprising application specific data, an application identifier, a first subscriber identifier to an exposure function node. The application node 880 further comprises a first receiving module 882 configured to receive a first response from the exposure function node.

In an embodiment, the application node 880 further comprises a second sending module 883 configured to send a third request for retrieving or updating or modifying or deleting the application specific data for the first subscriber identifier and the application identifier or for the application identifier to the exposure function node.

In an embodiment, the application node 880 further comprises a second receiving module 884 configured to receive a third response from the exposure function node.

Further, the exemplary overall commutation system including the terminal device and the network node (such as the exposure function node, the data repository node, the data management node or the application node) will be introduced as below.

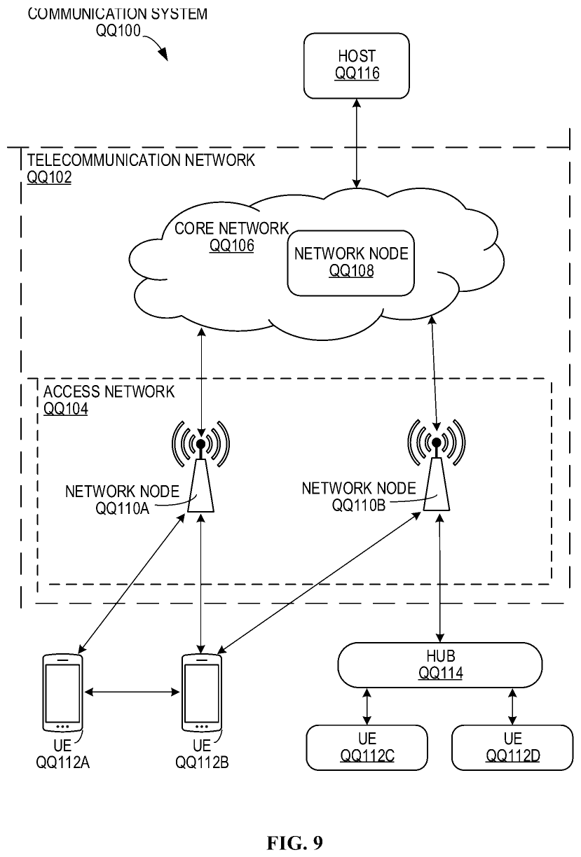

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

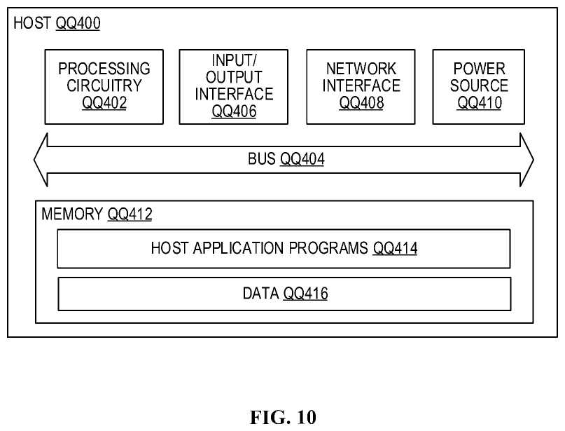

FIG. 10 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

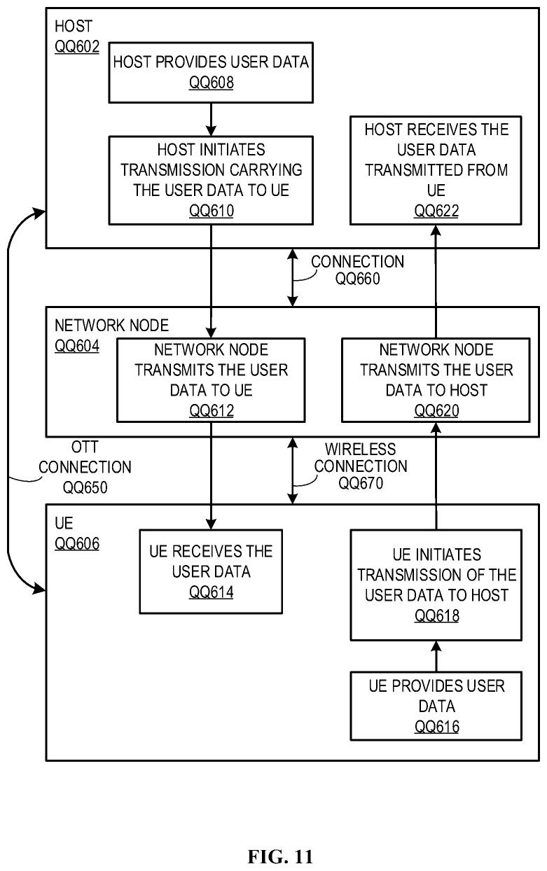

FIG. 11 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 10) discussed in the preceding paragraphs will now be described with reference to FIG. 11.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, it may allow applications to use the MNO's network in a sort of Storage as a Service (Saas) by exposing (via API) the reliability and robustness of the network (e.g., 5GS) subscription data repository (e.g., UDR). In some embodiments herein, applications no longer require a local storage and a synchronization of the MNO subscription and the application's account, since the ASD is keyed/accessed by using directly the subscriber identifier such as MSISDN. In some embodiments herein, it may allow applications to store and query ASD in an open/flexible and extensible format in MNO's central repository (e.g., UDR) to offer the redundancy, persistency, high availability (e.g. via data replication and/or distributed database) of ASD data in MNO network.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising: providing user data for the UE; and
initiating a transmission carrying the user data to the UE via a cellular network comprising the network node, wherein the UE performs the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the exposure function node or the data repository node may not need a fixed processor or memory, any computing resource and storage resource may be arranged from the exposure function node or the data repository node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-59. (canceled)

60. A method performed by an exposure function node, comprising:
receiving a first request comprising application specific data, an application identifier, a first subscriber identifier from an application node; and
sending a second request comprising the application specific data, the application identifier, the first subscriber identifier or a second identifier associated to the first subscriber identifier to a data repository node.

61. The method according to claim 60, wherein one or more of
the first request comprises at least one of:
a service parameter create request; or
an application specific data storage create request; and
the second request comprises a data management create request;
an access to the application specific data is only offered to an application managing the application specific data; and
the application specific data comprises information in a form of attribute and value pairs.

62. The method according to claim 60, wherein one or both of:
the first subscriber identifier comprises at least one of:
a mobile subscriber integrated services digital network number (MSISDN); or
an external identifier; and
the second identifier comprises a user equipment identifier, and wherein the user equipment identifier comprises at least one of:
an international mobile subscription identity (IMSI); or
a subscription permanent identifier (SUPI).

63. The method according to claim 60, further comprising one or both:
a) authorizing the first request for the application node; and when an authorization of the first request for the application node is not granted, one or both sending to the application node a first response comprising information indicating the authorization of the first request for the application node is not granted and skipping sending the second request to the data repository node; and
b) sending a first service specific authorization create request comprising the first subscriber identifier, a service type corresponding to the application specific data, and the application identifier to a data management node;
receiving a first service specific authorization create response comprising an authorization result from the data management node; and
when the authorization result indicates that a service specific authorization is not granted, one or both sending to the application node a first response comprising information indicating the service specific authorization is not granted and skipping sending the second request to the data repository node.

64. The method according to claim 60, further comprising one or both:
a) receiving a second response comprising information indicating the application specific data has been stored in the data repository node from the data repository node; and
sending a first response comprising information indicating the application specific data has been stored in the data repository node to the application node; and
b) receiving a third request for retrieving or updating or modifying or deleting the application specific data for the first subscriber identifier and the application identifier or for the application identifier from the application node;
sending a fourth request for retrieving or updating or modifying or deleting the application specific data for the first subscriber identifier and the application identifier or for the application identifier to the data repository node;
receiving a fourth response comprising a retrieving result or an updating result or a modifying result or a deleting result from the data repository node; and
sending a third response comprising the retrieving result or the updating result or the modifying result or the deleting result to the application node.

65. The method according to claim 64, wherein the third request comprises at least one of:
a service parameter get request;
an application specific data get request;
a service parameter update request;
an application specific data storage update request;
a service parameter modification request;
an application specific data storage modification request;
a service parameter delete request; or
an application specific data delete request.

66. The method according to claim 64, wherein the fourth request comprises at least one of:
a data management query request;
a data management update request; or
a data management delete request.

67. The method according to claim 64, further comprising one or both:
authorizing the third request for the application node; and when an authorization of the third request for the application node is not granted, and one or both sending to the application node a third response comprising information indicating that the authorization of the third request for the application node is not granted and skipping sending the fourth request to the data repository node; and
sending a second service specific authorization create request comprising the first subscriber identifier, a service type corresponding to the application specific data, and the application identifier to a data management node;
receiving a second service specific authorization create response comprising an authorization result from the data management node; and
when the authorization result indicates that a service specific authorization is not granted, sending to the application node a third response comprising information indicating the service specific authorization is not granted and/or skipping sending the fourth request to the data repository node.

68. The method according to claim 60, wherein the exposure function node comprises a network exposure function (NEF);
wherein the application node comprises at least one of:
an application servers (AS),
a services capability server (SCS), or
an application function (AF); and/or
wherein the data repository node comprises a unified data repository (UDR).

69. A method performed by a data repository node, comprising:
receiving a second request comprising application specific data, an application identifier, a first subscriber identifier or a second identifier associated to the first subscriber identifier from an exposure function node;
storing the application specific data for the application identifier and the first subscriber identifier or the second identifier associated to the first subscriber identifier; and
sending a second response comprising information indicating the application specific data has been stored in the data repository node to the exposure function node.

70. The method according to claim 69, wherein one or more of:
the second request comprises a data management create request;
an access to the application specific data is only offered to an application managing the application specific data;
the application specific data comprises information in a form of attribute and value pairs; and
one of both of:
the first subscriber identifier comprises at least one of:
a mobile subscriber integrated services digital network number (MSISDN); or
an external identifier; and
the second identifier comprises a user equipment identifier; and optionally wherein the user equipment identifier comprises at least one of:
an international mobile subscription identity (IMSI); or
a subscription permanent identifier (SUPI).

71. The method according to claim 69, further comprising:
receiving a fourth request for retrieving or updating or modifying or deleting the application specific data for the first subscriber identifier and the application identifier or for the application identifier from the exposure function node; and
sending a fourth response comprising a retrieving result or an updating result or a modifying result or a deleting result to the exposure function node.

72. The method according to claim 71, wherein the fourth request comprises at least one of:
a data management query request;
a data management update request; or
a data management delete request.

73. The method according to claim 69, wherein one or both:
the exposure function node comprises a network exposure function (NEF); and
the data repository node comprises a unified data repository (UDR).

74. An exposure function node, comprising:
a processor; and
a memory coupled to the processor, said memory containing instructions executable by said processor, to configure the exposure function node to:
receive a first request comprising application specific data, an application identifier, a first subscriber identifier from an application node; and
send a second request comprising the application specific data, the application identifier, the first subscriber identifier or a second identifier associated to the first subscriber identifier to a data repository node.

75. The exposure function node according to claim 74, wherein one or more of:
the first request comprises at least one of:
a service parameter create request; or
an application specific data storage create request;
the second request comprises a data management create request;
an access to the application specific data is only offered to an application managing the application specific data; and
the application specific data comprises information in a form of attribute and value pairs.

76. The exposure function node according to claim 74, wherein one or both of:
the first subscriber identifier comprises at least one of:
a mobile subscriber integrated services digital network number (MSISDN); or
an external identifier; and
the second identifier comprises a user equipment identifier, and the user equipment identifier comprises at least one of:
an international mobile subscription identity (IMSI); or
a subscription permanent identifier (SUPI).

77. The exposure function node according to claim 74, wherein the exposure function node is further configured to one or both:
a) authorize the first request for the application node; and
when an authorization of the first request for the application node is not granted, one or both send to the application node a first response comprising information indicating the authorization of the first request for the application node is not granted and skip sending the second request to the data repository node; and
b) send a first service specific authorization create request comprising the first subscriber identifier, a service type corresponding to the application specific data, and the application identifier to a data management node;
receive a first service specific authorization create response comprising an authorization result from the data management node; and
when the authorization result indicates that a service specific authorization is not granted, one or both send to the application node a first response comprising information indicating the service specific authorization is not granted and skip sending the second request to the data repository node.

78. The exposure function node according to claim 74, wherein the exposure function node is further configured to one or both:
a) receive a second response comprising information indicating the application specific data has been stored in the data repository node from the data repository node; and
send a first response comprising information indicating the application specific data has been stored in the data repository node to the application node; and
b) receive a third request for retrieving or updating or modifying or deleting the application specific data for the first subscriber identifier and the application identifier or for the application identifier from the application node;
send a fourth request for retrieving or updating or modifying or deleting the application specific data for the first subscriber identifier and the application identifier or for the application identifier to the data repository node;
receive a fourth response comprising a retrieving result or an updating result or a modifying result or a deleting result from the data repository node; and
send a third response comprising the retrieving result or the updating result or the modifying result or the deleting result to the application node.

79. The exposure function node according to claim 78, wherein the exposure function node is further configured to one or both:
a) authorize the third request for the application node; and
when an authorization of the third request for the application node is not granted, one or both send to the application node a third response comprising information indicating that the authorization of the third request for the application node is not granted and skip sending the fourth request to the data repository node; and
b) send a second service specific authorization create request comprising the first subscriber identifier, a service type corresponding to the application specific data, and the application identifier to a data management node;
receive a second service specific authorization create response comprising an authorization result from the data management node; and
when the authorization result indicates that a service specific authorization is not granted, one or both send to the application node a third response comprising information indicating the service specific authorization is not granted and skip sending the fourth request to the data repository node.
